(19) United States
(12) Patent Application Publication
(10) Pub. No.: US 2019/0347075 A1
(43) Pub. Date: Nov. 14, 2019

(54) RANDOM NUMBER GENERATION METHOD, RANDOM NUMBER GENERATOR, AND COMMUNICATION APPARATUS INCLUDING THE SAME

(71) Applicant: WIZnet Co., LTD., Seongnam-si (KR)

(72) Inventors: Woo Youl KIM, Seoul (KR); Deok Hwan JIN, Seoul (KR)

(73) Assignee: WIZnet Co., LTD., Seongnam-si (KR)

(21) Appl. No.: 16/057,823

(22) Filed: Aug. 8, 2018

(30) Foreign Application Priority Data
May 8, 2018 (KR) 10-2018-0052446

(51) Int. Cl. G06F 7/58

(52) U.S. Cl. CPC G06F 7/588

(57) ABSTRACT

A random number generation method includes: extracting a network data transmitted through a short distance network; determining a parameter to be updated among a plurality of parameters including a seed parameter used for random number generation using the extracted network data; updating the determined parameter using the extracted network data; and generating a random number according to a set random number generation algorithm using the seed parameter as an input variable.

### CROSS REFERENCE TO RELATED APPLICATION

The present application is based on and claims priority to Korean Patent Application No. 2018-0052446 filed in the Korean Intellectual Property Office on May 8, 2018, the entire contents of which are incorporated herein by reference.

### BACKGROUND OF THE INVENTION

### Field of the Invention

The present invention relates to a random number generation method, a random number generator and a communication apparatus including the same, and specifically, to a random number generation method, a random number generator and a communication apparatus including the same for generating a true random number using network packets transmitted and received through a network.

### Background of the Related Art

Random number generators (RNGs) are widely used. The random number generators generate an arbitrary random number according to an algorithm for generating a random number using a seed, a poly or the like as an input variable.

The algorithm of the random number generator may generate and output an arbitrary random number according to the inputted seed or poly. Generally, since a seed is selected through a seed table or the like and provided to the random number generator, if the seed is known or can be inferred, it is possible to know the random number generated by the random number generator. In addition, a series of random numbers generated after input of the seed also can be inferred.

The generated random numbers are used for various purposes. For example, the generated random numbers are used for various purposes, such as a hash key, a security key and the like, in which a random number is needed. Particularly, random numbers generated for a security key used for network security generate a lot of problems when they are exposed to the outside or can be predicted.

A random number generator generating a random number according to some specified seeds is also referred to as a pseudo random number generator (PRNG). Since the pseudo random number generator generates and outputs a random number having a predetermined pattern according to an input seed, there is a limit in using the random number as a security key.

Therefore, it needs to provide a random number generator of a true sense, which does not have a predetermined generation pattern within the range of all numbers. Such a random number generator is also referred to as a true random number generator (TRNG).

Although the true random number generator generates a random number by randomly selecting a seed, there is a limit due to the constraints in selecting a seed.

Like this, a random number generation method, a random number generator and a communication apparatus including the same, which do not allow prediction of a generated random number, are needed.

### SUMMARY OF THE INVENTION

The present invention has been made to solve the above problems, and it is an object of the present invention to provide a random number generation method, a random number generator and a communication apparatus including the same, which generate a random number using transmitted and/or received network packets.

In addition, another object of the present invention is to provide a random number generation method, a random number generator and a communication apparatus including the same, which make it difficult to analyze a pattern of a generated random number by arbitrarily setting various parameters and random number generation algorithms used for generation of random numbers using network packets.

In addition, another object of the present invention is to provide a random number generation method, a random number generator and a communication apparatus including the same, which make an analysis difficult by extracting packets of the data link layer according to an arbitrarily set index and generating a random number through hardware logic which generates the random number using the extracted packets.

The technical problems to be solved by the present invention are not limited to those mentioned above, and unmentioned other technical problems may be clearly understood by those skilled in the art from the following descriptions.

A random number generation method executed by a communication apparatus according to an aspect of the present invention includes the steps of: extracting a network data transmitted through a short distance network; determining a parameter to be updated among a plurality of parameters including a seed parameter used for random number generation using the extracted network data; updating the determined parameter using the extracted network data; and generating a random number according to a set random number generation algorithm using the seed parameter as an input variable.

In addition, the step of extracting a network data extracts, among valid network data, a network data positioned behind a previously extracted network data as much as a number set in an index parameter included in the plurality of parameters.

In addition, the step of determining a parameter to be updated determines the parameter to be updated using the extracted network data among the plurality of parameters through a modular arithmetic operation performed on a value of a counter operated by a predetermined clock, and the step of updating the determined parameter sets a data created by processing the network data to the determined parameter.

In addition, the plurality of parameters include at least a seed parameter, a poly parameter and an index parameter, and the step of determining a parameter to be updated determines a corresponding parameter determined among the seed parameter, the poly parameter and the index parameter through a modular arithmetic operation performed on the counter value as the parameter to be updated, and the step of updating the determined parameter sets a data created by scrambling the network data to the determined parameter.

In addition, the step of updating the determined parameter sets the determined parameter as a scrambled data and initializing the index parameter when the determined parameter is the seed parameter or the poly parameter and the index parameter is set in advance through a previous update, and the determined parameter is not set when the index parameter is in an initialized state.

In addition, the plurality of parameters further include a poly parameter and an algorithm-index parameter, and the step of generating a random number generates the random number according to a random number generation algorithm set in correspondence to the algorithm-index parameter updated with the network data by further using the poly parameter updated with the extracted network data as an input variable, and the network data is a data contained in a data link layer packet and having a predetermined size.

A random number generator according to an aspect of the present invention includes: a data reception unit for receiving a network data through a short distance network; a data extraction unit for extracting a network data to be used for parameter update from a plurality of network data received from the data reception unit; a plurality of storage units for storing a plurality of parameters including a seed parameter, respectively; a selection unit for selecting a storage unit corresponding to a parameter to be updated among the plurality of parameters of the plurality of storage units using the extracted network data; and a random number generation unit for generating a random number according to a set random number generation algorithm using the seed parameter as an input variable.

In addition, the data extraction unit extracts, among valid network data, a network data positioned behind a previously extracted network data as much as a data value stored in a storage unit corresponding to an index parameter included in the plurality of parameters, as a data to be used for parameter update.

In addition, the selection unit including a counter operated by a predetermined clock and a modular arithmetic logic connected to an output value of the counter selects a storage unit corresponding to a parameter to be updated using the extracted network data among the plurality of parameters through a modular arithmetic operation performed on an output value of the counter, and the storage unit corresponding to the selected parameter among the plurality of storage units stores a data created by processing the network data extracted by the data extraction unit.

In addition, the plurality of parameters include at least a seed parameter, a poly parameter and an index parameter, and the selection unit selects a storage unit corresponding to a parameter determined among the seed parameter, the poly parameter and the index parameter through a modular arithmetic operation performed on an output value of the counter, as a storage unit of the parameter to be updated, and the data extraction unit outputs a data created through scrambling of the extracted network data to the selection unit.

A communication apparatus according to an aspect of the present invention includes: the random number generator described above; and a central processing unit for transmitting and receiving data to and from the random number generator, wherein the central processing unit requests the random number generator to generate a random number, and the random number generator transmits a random number generated in response to the request to the central processing unit.

The random number generation method, a random number generator and a communication apparatus including the same according to the present invention as described above has an effect of generating a random number using transmitted and/or received network packets.

In addition, the random number generation method, a random number generator and a communication apparatus including the same according to the present invention as described above has an effect of making it difficult to analyze a pattern of a generated random number by arbitrarily setting various parameters and random number generation algorithms used for generation of random numbers using network packets.

In addition, the random number generation method, a random number generator and a communication apparatus including the same according to the present invention as described above has an effect of making an analysis difficult by extracting packets of the data link layer according to an arbitrarily set index and generating a random number through hardware logic which generates the random number using the extracted packets.

The effects that can be obtained from the present invention are not limited to the effects mentioned above, and unmentioned other effects will be clearly understood by those skilled in the art from the following description.

### BRIEF DESCRIPTION OF THE DRAWINGS

FIG. 1 is a view showing a simplified exemplary communication system for describing the present invention.

FIG. 2 is a view showing an exemplary block diagram of a communication apparatus.

FIG. 3 is a view showing an exemplary configuration block diagram of a random number generator.

FIG. 4 is a view showing an example of extracting a network data using index parameters.

FIG. 5 is a view showing an exemplary control flow for generating a random number.

### DESCRIPTION OF SYMBOLS

10: Communication apparatus
110: Storage unit
120: Input/output unit
130: Random number generator
131: Data reception unit
132: Data extraction unit
133: Selection unit
133-1: Storage selector
133-2: Counter
133-3: Modular arithmetic logic
134: Storage unit
135: Random number generation unit
135-1: First algorithm arithmetic logic
135-2: Second algorithm arithmetic logic
135-3: Third algorithm arithmetic logic
135-4: Algorithm selector
135-5: Random number storage unit
136: Control unit
140: Communication port
150: Central processing unit
20: Short distance network

### DETAILED DESCRIPTION OF THE PREFERRED EMBODIMENT

The objects, features and advantages described above may be further clear through the detailed description described below in detail with reference to the accompanying drawings. Accordingly, those skilled in the art may easily embody the spirit of the present invention. In addition, in describing the present invention, when it is determined that the detailed description of the known art related to the present invention may obscure the gist of the present invention, the detailed description thereof will be omitted. Hereinafter, the preferred embodiments of the present invention will be hereafter described in detail with reference to the accompanying drawings.

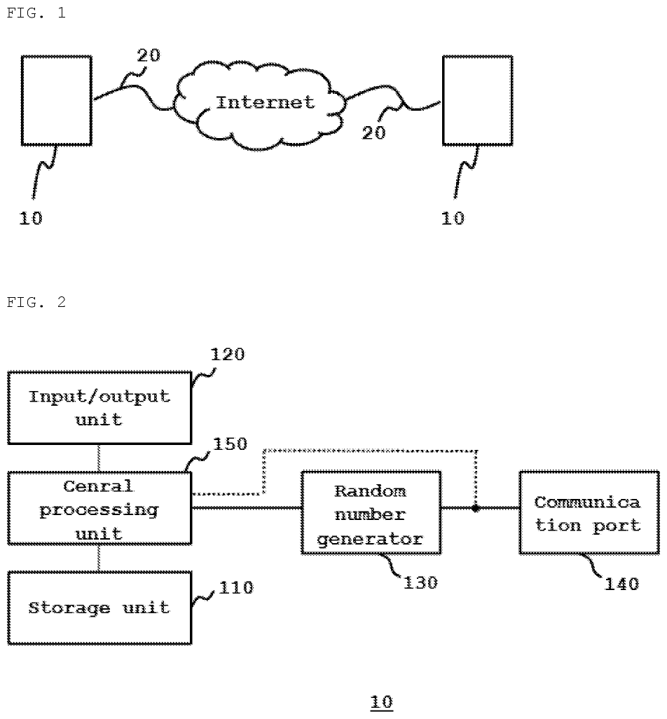

FIG. 1 is a view showing a simplified exemplary communication system for describing the present invention.

According to FIG. 1, a communication system includes one or more communication apparatuses 10, and each of the communication apparatuses 10 is connected to the Internet through a short distance network 20.

Describing the communication system of FIG. 1 briefly, the communication apparatus 10 is connected to the Internet and performs data communication with another communication apparatus 10 through the Internet. The communication apparatus 10 may transmit and receive communication packets based on TCP/IP or UDP to and from the another communication apparatus 10 through the Internet. The communication apparatus 10 is an apparatus at least capable of connecting to the short distance network 20 and may be, for example, a cellular phone, a smart phone, a notebook computer, a PC, various devices or apparatuses requiring communication, or the like. The communication apparatus 10 may perform dedicated functions, as well as communication functions, and may also perform communication functions in the process performing the dedicated functions.

Due to the security problems of the Internet, the communication apparatus 10 may establish a security channel with the another communication apparatus 10 and transmit and receive various data or control data on the established security channel. The security channel is set on a communication layer (e.g., SHTTP) higher than TCP/IP or UDP.

The communication apparatuses 10 may generate a random number according to the present invention, generate a security key on the basis of the generated random number, and exchange or set the security key with each other to establish the security channel.

The communication apparatuses 10 like this may safely transmit and receive various data using the security key or the like generated according to the random number generated according to the present invention.

The communication apparatuses 10 may be connected to the Internet through the short distance network 20. For example, the communication apparatuses 10 may be connected to an Internet network through a gateway, a router, an access point or the like using various short distance communication techniques such as Ethernet, Wi-Fi, Bluetooth, Zigbee and the like.

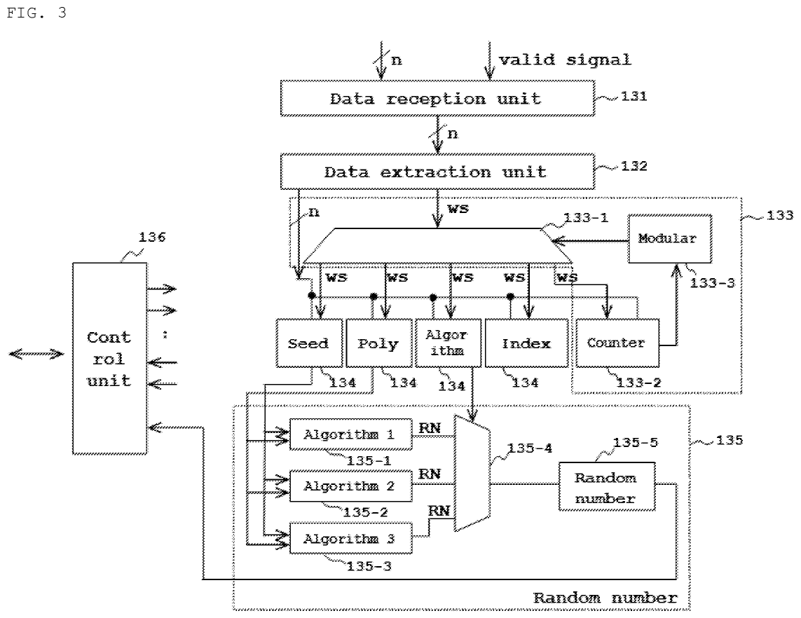

FIG. 2 is a view showing an exemplary block diagram of a communication apparatus 10.

According to FIG. 2, the communication apparatus 10 includes a storage unit 110, an input/output unit 120, a random number generator 130, a communication port 140 and a central processing unit 150. The communication apparatus 10 may not include some of the blocks according to modification of design. Or, the communication apparatus 10 may further include blocks not shown in FIG. 2. Or, a specific block may be embedded in another block according to design examples. For example, the random number generator 130 may be embedded in the central processing unit 150.

Describing the configuration of the communication apparatus 10 through FIG. 2, the storage unit 110 includes volatile memory, nonvolatile memory and/or large capacity storage medium such as hard disk and stores various data and programs. For example, the storage unit 110 stores programs for transmitting and receiving various data through the Internet and controlling the communication apparatus 10 and data that can be used by the communication apparatus 10. For example, the storage unit 110 stores a communication program for implementing a standard protocol used on a communication layer higher than the TCP/IP layer. This communication program may generate a security key or the like using the random number generator 130 and transmit and receive data to and from the another communication apparatus 10 through the security channel established using the security key.

The input/output unit 120 may be provided with input means such as buttons, a touch pad, a touch panel, a mouse, a keyboard and the like and output means such as a display, an LED, a speaker and the like to receive various user inputs and output various internal states of the communication apparatus 10 or a response to an input.

The communication port 140 transmits and receives various short distance network packets through the short distance network 20. The communication port 140 may be provided with a terminal for connecting to a wired line, or an antenna for transmitting and receiving wireless signals. The communication port 140 may transmit and receive various network packets using short distance communication techniques such as Ethernet, Wi-Fi, Bluetooth, Zigbee and the like.

In addition to the terminal and the antenna, the communication port 140 may further include a chipset capable of extracting short distance network packets from wired signals or wireless signals. For example, the communication port 140 may include a PHY chipset for extracting short distance network packets at a data link layer. This PHY chipset extracts network data that can represent communication packets of the data link layer from wired signals or wireless signals and outputs a series of extracted network data, together with a valid signal, to the central processing unit 150 and/or the random number generator 130. The central processing unit 150 and/or the random number generator 130 may extract network data set by the valid signal and generate a random number from the extracted network data or may reconstruct network packets of the data link layer from a series of continuous valid network data (e.g., 4-bit or 8-bit data).

In addition, the communication port 140 may be connected to a mobile communication network. For example, the communication port 140 may be provided with an antenna and a communication chipset for connecting to an LTE network or the like.

The random number generator 130 generates a random number using the network data. The random number generator 130 may be constructed using software or hardware. When the random number generator 130 is constructed by software, the function of the random number generator 130 may be embedded in the central processing unit 150 through a program of the storage unit 110. Preferably, the random number generator 130 is constructed by hardware (logic). The random number generator 130 may store various parameters (variables) needed for random number generation and generate a random number by hardware logic using the stored various parameters, a counter, a selector and the like.

The random number generator 130 is configured to be connected to the communication port 140 to preferably generate a random number using random network data (packet data received from the short distance network 20) received from the communication port 140. Preferably, the random number generator 130 constructed by hardware logic may be constructed using a register transfer language (RTL). The random number generator 130 of hardware logic may be implemented as a chipset separated from the central processing unit 150 or embedded to be accessible by an internal execution unit in the central processing unit 150.

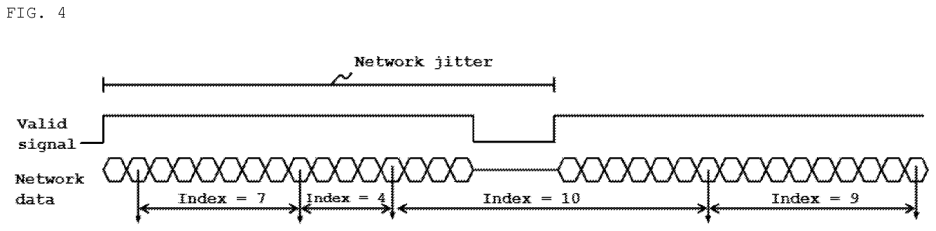

The random number generator 130 will be described in detail with reference to FIG. 3.

The central processing unit 150 controls the communication apparatus 10 using a program of the storage unit 110. The central processing unit 150 includes one or more execution units capable of executing commands of a program and may load a program of the storage unit 110 and execute various program command codes. The central processing unit 150 may represent or may be referred to as a CPU, an MPU, an MICOM or the like.

The central processing unit 150 capable of data communication with another communication apparatus 10 may establish a security channel with the another communication apparatus 10 through the Internet. In the process of establishing the security channel, the central processing unit 150 generates a random number used for generation of a security key. For example, the central processing unit 150 requests the random number generator 130 to generate a random number according to a promised command format when a random number is needed according to various applications or needs. In response to the random number generation command (request), the random number generator 130 generates a random number using a network data and transmits the random number to the central processing unit 150.

The random number generator 130 and the central processing unit 150 have a communication interface capable of transmitting and receiving data. For example, the central processing unit 150 may transmit and receive various control commands and responses, states or data according to the control commands to and from the random number generator 130 through a serial bus (UART, RS232, SPI or the like).

In addition, the central processing unit 150 may receive a series of network packet data on the data link layer directly from the communication port 140.

Or, according to design examples, the central processing unit 150 may transmit and receive various network data through the Internet by way of the random number generator 130. For example, the central processing unit 150 transmits a series of network data representing TCP/IP or UDP packets to the random number generator 130 through a serial bus or the like. In addition to the random number generation function, the random number generator 130 may automatically convert TCP/IP packets or UDP packets into network packets of the data link layer through hardware logic devised by the inventors of the present invention and output the converted network packets to the communication port 140.

Conversions from a TCP packet into an IP packet and into a data link packet may be implemented by hardware logic embedded in the random number generator 130 and may be accomplished to be independent from the random number generation function.

FIG. 3 is a view showing an exemplary configuration block diagram of a random number generator 130. The random number generator 130 of FIG. 3 may be implemented as a separate chipset outside the central processing unit 150 of the communication apparatus 10 or may be embedded inside the central processing unit 150. In addition, the random number generator 130 may be embedded (included) and used in an apparatus accessible through the short distance network 20 and having certain other usages or functions, as well as an apparatus dedicated to communication.

The example of FIG. 3 preferably shows an example of implementing the random number generator 130 as a separate chipset, and when the random number generator 130 is implemented as a separate chipset, each of the blocks of the random number generator 130 may be constructed by hardware logic implemented using RTL or the like.

Describing the random number generator 130 with reference to FIG. 3, the random number generator 130 includes a data reception unit 131, a data extraction unit 132, a plurality of storage units 134, a selection unit 133, a random number generation unit 135 and a control unit 136.

The data reception unit 131 receives network data through the short distance network 20. The data reception unit 131 is connected to the communication port 140 and receives 4-bit (n=4) or 8-bit (n=8) data, together with a valid signal, from the PHY chip or the like of the communication port 140. The data reception unit 131 may recognize a network data corresponding to the valid signal and extract valid packet data.

For reference, the PHY chip is synchronized with a preamble contained in the network packet and is able to extract a series of data packets following the preamble and output the packet data to the data reception unit 131. Like this, the network data received through the data reception unit 131 is a data contained in a data link layer packet of the short distance network 20, which is a data having a size (e.g., four bits, eight bits or the like) determined according to the interface to the PHY chip of the communication port 140.

The data extraction unit 132 extracts network data to be used for update of the parameter(s) used for random number generation from a plurality of network data received from the data reception unit 131.

The data extraction unit 132 is preferably configured to determine network data to be extracted by the parameters of the storage unit 134.

For example, the data extraction unit 132 receives an index data from the storage unit 134 storing index parameters, and the data extraction unit 132 extracts a network data positioned behind a network data extracted immediately before (previously) as much as an index data value, among the data indicated as valid by the valid signal, as a network data to be used for update of a certain parameter among several parameters.

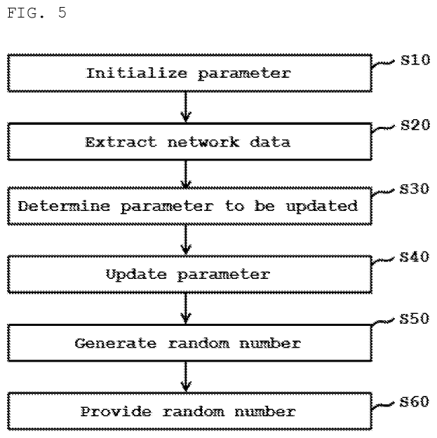

As shown in the example of FIG. 4, according to a value of the inputted index parameter, the data extraction unit 132 may extract a network data corresponding to the value of the index parameter (e.g., a seventh, fourth, tenth or eighth network data) from a series of sequentially received network data (e.g., received in synchronization with 12.5 MHz). Each of the index parameters may be changed, and preferably, if a network data to used for parameter update is extracted, the index parameter is changed or initialized at the same time.

The data extraction unit 132 processes the extracted 4-bit or 8-bit network data and outputs the processed network data to be stored (updated) in the storage unit 134 of the parameter.

The data extraction unit 132 processes the extracted network data by scrambling the extracted network data or through an operation, such as XOR or the like, with another (previously extracted) network data and outputs a data created by the process.

Specifically, the data extraction unit 132 may output a data created by scrambling and/or XORing the extracted network data, the index parameter and/or a series of valid network data to the selection unit 133 or the storage unit 134.

For example, the data extraction unit 132 may output a data created by internal bit scrambling performed on an extracted single network data or output a data created by scrambling the extracted single network data, an accumulated network data (the accumulated network data is a data created by a process (e.g., sequential XOR or the like) performed on a plurality of single network data), the index parameter, and furthermore an XOR operation data to the selection unit 133 or the storage unit 134.

In addition, the data extraction unit 132 may create a data by performing an operation further using an embedded free-running counter 133-2 and output the data to the selection unit 133 or the storage unit 134. Like this, the data extraction unit 132 creates a data to be outputted to the selection unit 133 or the like by performing various processes (e.g., various encryption techniques such as scrambling, XOR and the like) on the extracted network data.

The data extraction unit 132 may further output a write signal informing to store the created data, in addition to output of the created data. The write signal is inputted in the storage unit 134 of a specific parameter, and a network data outputted to the storage unit 134 of a corresponding parameter may be stored.

The plurality of storage units 134 of the random number generator 130 store a plurality of parameters, respectively. Each of the storage units 134 may be an 8-bit, 16-bit or 32-bit register configured of flip-flop or the like. The parameters stored in the plurality of storage units 134 include, for example, a seed parameter, a poly parameter, an algorithm-index parameter, an index parameter and the like.

Parameters of the storage units 134 are used at least to generate a random number. For example, they are to determine an algorithm for generating a random number (the algorithm-index parameter), used as an input variable of the determined algorithm (the seed parameter, the poly parameter), or used to dynamically determine an algorithm and a variable using a network data (an index parameter).

A storage unit 134 corresponding to a parameter sets (stores) the processed network data according to a control signal such as a write signal. A storage unit 134 corresponding to the seed parameter and the poly parameter may be, for example, a 32-bit data storage register. The control unit 136 may control the storage register to store the network data in a predetermined bit area (4-bit or 8-bit area) among 32 bits to configure a 32-bit seed parameter or poly parameter using several network data (e.g., eight or four network data). The index parameter and the algorithm-index parameter may be a register having bits as many as the number of bits (n=4 or 8) of an outputted network data.

The selection unit 133 selects a storage unit 134 corresponding to a parameter to be updated among the plurality of parameters of the plurality of storage units 134 using the extracted network data. The selection unit 133 includes a storage selector 133-1, a counter 133-2 and a modular arithmetic logic 133-3 and may select a storage unit 134.

The counter 133-2 increases by one by a predetermined clock provided in the random number generator 130 and is initialized (to zero) when the count arrives at a predetermined maximum value. For example, the counter 133-2 may be formed in eight bits, synchronized with an input clock to increase by one each time, and initialized to zero when the counter arrives at a prime number (e.g., 251 or the like) that can be set by eight bits, and the counter 133-2 increases again thereafter. The counter 133-2 is preferably configured using a clock different from a clock (e.g., 12.5 MHz or the like) used for extraction of a network data.

The modular arithmetic logic 133-3 is connected to the counter 133-2 and performs a modular arithmetic operation on an output value of the counter 133-2. For example, when the storage unit 134 (and the counter 133-2) set by the selection unit 133 is N (e.g., N=4.5 or the like), the modular arithmetic logic 133-3 performs an N-modular arithmetic operation and outputs a signal corresponding to a modular arithmetic value between zero and N−1.

The modular arithmetic logic 133-3 outputs a selection signal to the storage selector 133-1, and the modular arithmetic logic 133-3 may be omitted according to design examples. For example, when the data extraction unit 132 creates and outputs a selection signal for selecting a storage selector 133-1 according to modification of design, the modular arithmetic logic 133-3 may omitted.

In this case, the data extraction unit 132 may create a selection signal through various operations (e.g., scrambling, XOR and the like) using the extracted network data so that the storage selector 133-1 may select an arbitrary storage unit 134 and output the created signal to the storage selector 133-1.

The storage selector 133-1 is connected to the modular arithmetic logic 133-3 or the data extraction unit 132 and selects a storage unit 134 corresponding to a parameter to be updated among the plurality of parameters using the processed network data according to a modular output value (a selection signal, for example, a 2-bit signal or a 3-bit signal) outputted from the modular arithmetic logic 133-3. For example, the storage selector 133-1 outputs a write signal received from the data extraction unit 132 to a corresponding storage unit 134 (or the counter 133-2) according to a modular output value, to select one among the seed parameter, the ploy parameter, the algorithm-index parameter, the index parameter, and furthermore the counter 133-2. The counter 133-2 may also be set again using the processed network data. According thereto, a storage unit 134 corresponding to the selected parameter, among the plurality of storage units 134 and the counter 133-2, stores a data created by processing the network data according to the write signal.

The random number generation unit 135 generates a random number using an algorithm used for random number generation. The random number generation unit 135 generates a random number according to an internally set random number generation algorithm using the seed parameter as an input variable and outputs the random number.

The random number generation unit 135 may have a plurality of random number generation algorithms. For example, the random number generation unit 135 may have hardware logic for implementing a linear congruential random number generation algorithm, a blum-blum-shub random number generation algorithm or a modification thereof, an ARM-series random number generation algorithm, and other random number generation algorithms.

For example, the random number generation unit 135 is provided with three algorithm arithmetic logics for random number generation as shown in the example of FIG. 3, and a first algorithm arithmetic logic 135-1 generates a linear congruential random number using a seed parameter of a corresponding storage unit 134 and a poly parameter of a corresponding storage unit 134 (and furthermore a random number generated immediately before, and this random number is a data of the random number storage unit 135-5 or a random number generated in itself).

A second algorithm arithmetic logic 135-2 generates a blum-blum-shub random number using a seed parameter of a corresponding storage unit 134 and a poly parameter of a corresponding storage unit 134 (and furthermore a random number generated immediately before, and this random number is a data of the random number storage unit 135-5 or a random number generated in itself).

In addition, a third algorithm arithmetic logic 135-3 generates a random number according to an ARM-series random number generation algorithm using a corresponding poly parameter (and furthermore a random number generated immediately before, and this random number is a data of the random number storage unit 135-5 or a random number generated in itself) of the storage unit 134.

Each of the algorithm arithmetic logics is preferably formed as hardware logic, and although FIG. 3 shows an example of three algorithm arithmetic logics, various modified embodiments exist other than this.

Like this, the random number generator 130 may generate a random number, a pattern of which cannot be analyzed, using dynamically selected and processed network data as various input variables. At least, the random number generator 130 according to the present invention makes it difficult to infer seed and poly parameters when they are created.

The random number generation unit 135 further includes an algorithm selector 135-4 and a random number storage unit 135-5. The algorithm selector 135-4 outputs a random number selected among several random numbers calculated and outputted by several algorithm arithmetic logics according to an algorithm-index parameter value of the storage unit 134, and the random number storage unit 135-5 stores the random number outputted from the algorithm selector 135-4. The random number storage unit 135-5 may store the random number outputted according to a write signal outputted from an algorithm arithmetic logic selected by the control unit 136 or the algorithm-index parameter.

The control unit 136 controls operation of the random number generator 130 and interfaces with the central processing unit 150 of the communication apparatus 10. The control unit 136 is provided with registers that can be accessed by the central processing unit 150 and hardware logic for accessing the registers and implements random number generation and initialization of the random number generator 130, initialization of the storage unit 134 and like under the control of the central processing unit 150.

The registers include a command register and a state register, and the control unit 136 may generate a random number through the data reception unit 131, the data extraction unit 132, the selection unit 133, the storage units 134, and the random number generation unit 135 according to a generation command or the like requesting random number generation, which is recorded in the command register by the central processing unit 150. The control unit 136 may record completion of the random number generation in the state register when the random number generation is completed and inform the central processing unit 150 of completion of the random number generation through an interrupt or the like.

The control unit 136 may set and initialize various units in the early stage or during the process of generating a random number. The control unit 136 may be provided with a state machine therein and control various units.

Describing an example of the control performed by the control unit 136, the control unit 136 initializes a plurality of parameters of the storage units 134 when supply of power to the random number generator 130 begins (when the random number generator 130 is booted) or according to an initialization command received from the central processing unit 150. For example, the control unit 136 sets (initial setting) one or more parameters among (the storage unit 134 of) the seed parameter, (the storage unit 134 of) the index parameter, (the storage unit 134 of) the poly parameter and (the storage unit 134 of) the algorithm-index parameter using a certain value measured or set by the random number generator 130. The control unit 136 initializes one or more parameter values using a network jitter such as a time difference between a series of two valid signals outputted from the PHY chip of the communication port 140 (for example, see the network jitter of FIG. 4) or using a MAC address of the communication apparatus 10.

In addition, the control unit 136 may control update of a certain parameter through the selection unit 133. For example, when a parameter (seed, poly or algorithm-index parameter) is updated using the index parameter, the control unit 136 sets the index parameter to an initialized state (e.g., set in the state register of the control unit 136). Then, when a processed network data is not stored in the storage unit 134 of the index parameter through the selection unit 133, the control unit 136 may control not to store the network data outputted from the data extraction unit 132 in the storage unit 134 of the selected parameter. Through the configuration like this, the random number generator 130 may access a network packet using a variable random index and generate various parameters, without using the same index.

Alternatively, the selection unit 133 may select the storage units 134 of parameters other than the index parameter and the counter 133-2 as a storage of a processed network data. In this case, the data extraction unit 132 regenerates the index parameter, in addition to creating a network data. The regenerated index parameter may be generated through scrambling and an arithmetic operation performed on, for example, a received network data, a previous index parameter, and data on the counter or the like.

The control unit 136 recognizing completion of the random number generation may set a state indicating that random number generation is completed in the state register and inform the central processing unit 150 of completion of the random number generation.

After a random number is generated initially, random numbers are continuously generated and updated according to a selected algorithm. In the continuous and independent process of generating random numbers, each of the seed parameter, the ploy parameter and the like is also set again or changed using a recognized network data. The control unit 136 receiving a request for generating subsequent random numbers from the central processing unit 150 recognizes (catches) random numbers generated independently and in parallel by hardware logic and transfer the random numbers to the central processing unit 150.

Since random numbers are continuously generated after initialization and a parameter such as the seed or poly parameter is independently changed in the process of generation without control of the central processing unit 150, a pattern of the generated random numbers is difficult to analyze.

Although the random number generator 130 of FIG. 3 shows an example implemented as a chipset separated from the central processing unit 150, the random number generator 130 may be embedded in a chipset of the central processing unit 150. In this case, the control unit 136 of the random number generator 130 is configured to be connected to the internal bus (e.g., AMBA) of the central processing unit 150 to perform various processes.

The random number generator 130 implemented as a separate chipset may further include a plurality of other blocks, in addition to the blocks of FIG. 3. For example, the random number generator 130 may further include a buffer for transmitting and receiving session data, a TCP conversion unit for converting a session data into a TCP packet or a TCP packet into a session data, an IP conversion unit for converting a TCP packet into an IP packet or an IP packet into a TCP packet, and a data link conversion unit for converting an IP packet into a data link packet (e.g., an Ethernet packet or a Wi-Fi packet) or a data link packet into an IP packet. The buffer, the TCP conversion unit, the IP conversion unit and the data link conversion unit are implemented as hardware logic applied for patent and implemented by the inventors of the present invention.

FIG. 5 is a view showing an exemplary control flow for generating a random number.

The control flow of FIG. 5 is performed by the communication apparatus 10 through software, hardware or a combination of these. Preferably, the control flow of FIG. 5 is performed by the random number generator 130 implemented as a chipset separated from the central processing unit 150 and configured of hardware logic.

Each or some of the steps of FIG. 5 may be performed in parallel to each other. That is, step S20, step S30, step S40 and step S50 of FIG. 5 may be performed in parallel and to be independent from each other like pipeline parallelization or the like.

Since the random number generator 130 has already been described in detail with reference to FIGS. 3 and 4, it will be described herein focusing on the flow.

First, (the random number generator 130 of) the communication apparatus 10 initializes various parameters used for random number generation (step S10).

For example, as power is applied to (the random number generator 130 of) the communication apparatus 10 or an initialization request is received from the central processing unit 150, the seed parameter, the poly parameter, the index parameter of the storage unit 134 and/or the counter 133-2 is set using an initially recognized data. The initially recognized data may be, for example, a network jitter (e.g., a time difference between valid signals, see FIG. 4) or a MAC address.

The (random number generator 130 of the) communication apparatus 10 generates a random number thereafter according to a random number generation request command received from the central processing unit 150 or automatically using hardware.

First, (the random number generator 130 of) the communication apparatus 10 extracts a network data transmitted through the short distance network 20 (step S20).

For example, the data reception unit 131 receives short distance network data transmitted and received (transmitted) through the communication port 140, and the data extraction unit 132 extracts, among valid network data, a network data positioned behind a previously extracted network data as much as a number (a binary number, a hexadecimal number or the like) set in the index parameter, from a series of short distance network data using the index parameter of the storage unit 134.

The network data received and extracted through the data reception unit 131 is a data contained in a data link layer packet of the short distance network 20, which is a data having a size (e.g., four bits, eight bits or the like) set according to the interface with the PHY chip of the communication port 140.

The (random number generator 130 of the) communication apparatus 10 determines a parameter or the counter 133-2 to be updated among a plurality of parameters, such as the seed parameter, the poly parameter, the index parameter and the algorithm-index parameter, and furthermore the counter 133-2 of the selection unit 133 (step S30).

For example, the selection unit 133 determines a parameter to be updated among a plurality of parameters and furthermore the counter 133-2 using an extracted network data through a modular arithmetic operation performed on a value of the counter 133-2 operated by a predetermined clock. The modular arithmetic logic 133-3 outputs a remainder value generated by applying the modular arithmetic operation to an output value of the counter 133-2 (e.g., a value between zero and four in the case of modulo 5) to the storage selector 133-1, and the storage selector 133-1 may output a write signal generated by the data extraction unit 132 and furthermore a network data to the storage unit 134 (or the counter 133-2) of a parameter (the counter 133-2) corresponding to the remainder value among a plurality of parameters, such as the seed parameter, the poly parameter, the algorithm-index parameter and the index parameter, and furthermore the counter 133-2.

The (random number generator 130 of the) communication apparatus 10 updates the determined parameter using the extracted network data (step S40).

The data used for parameter update is generated from the network data received through the data reception unit 131 and extracted through the data extraction unit 132. For example, the data extraction unit 132 may output a data created by processing an XOR operation data on the extracted network data, the index parameter and/or a series of valid network data to the selection unit 133 or the storage unit 134. For example, the data extraction unit 132 may output a data created by internal bit scrambling performed on an extracted single network data or output a data created by scrambling the extracted single network data, the index parameter, and furthermore an XOR operation data of a series of network data to the selection unit 133 or the storage unit 134.

In the parameter update process, when a specified parameter is update, (the random number generator 130 of) the communication apparatus 10 may determine whether or not to update the parameter further using the index parameter used for network data selection.

For example, when the determined parameter is the seed parameter or the poly parameter and the index parameter is already set in advance as a valid data through a previous update, the control unit 136 controls to store a scrambled network data in a storage unit 134 corresponding to the seed parameter or the poly parameter.

When the seed parameter or the poly parameter is updated, the index parameter may be set again(reconfigured). For example, the data extraction unit 132 creates and outputs an index data to be set again(reconfigured) and sets the index data as the index parameter.

Alternatively, when the seed parameter or the poly parameter is updated, the control unit 136 initializes the index parameter to express unsetting. For example, the control unit 136 may initialize the index parameter by setting a flag in the internal state register to express unsetting of the index parameter. If a parameter determined is the seed parameter or the poly parameter while the index parameter is initialized, the control unit 136 controls (sets) not to update the seed parameter or the poly parameter.

Through the implementation as described above, the random number generator 130 may generate an unpredictable random number using a randomly accessed network data.

The (random number generator 130 of the) communication apparatus 10 generates a random number according to a random number generation algorithm using the parameters determined using the extracted network data as input variables (step S50).

For example, each of the algorithm arithmetic logics 135-1, 135-2 and 135-3 generates a random number according to a predetermined algorithm using the poly and/or seed parameter continuously updated using the extracted network data and furthermore a previously generated random number as input variables. The algorithm selector 135-4 outputs a random number selected according to the algorithm-index parameter and stores the random number in the random number storage unit 135-5 under the control of the control unit 136 or the like.

Through such a series of processes, random numbers may be continuously generated and continuously stored in the random number storage unit 135-5.

The central processing unit 150 of the communication apparatus 10 requests the random number generator 130 to generate a random number, and the random number generator 130 provides a random number generated in the random number storage unit 135-5 to the central processing unit 150 in response to the random number generation request (step S60).

When a random number is already generated, the control unit 136 outputs the generated random number to the central processing unit 150 and initializes the random number storage unit 135-5 as non-creation. If the random number generation request is received while a random number is not generated yet, the control unit 136 may set a state indicating non-creation of a random number in the state register until the random number generation is completed and output the state according to access of the central processing unit 150.

When a random number is generated by the random number generation unit 135 after the non-creation is set, the control unit 136 may set a state indicating completion of the random number generation in the state register and inform the central processing unit 150 of completion of the random number generation through an interrupt or the like. Then, the central processing unit 150 may access the random number storage unit 135-5 and read the random number through the control unit 136, and the control unit 136 may set again a state indicating non-creation of a random number in the state register.

For reference, one or a plurality of command registers for receiving a control of the central processing unit 150 and state registers for informing various states may exist in the control unit 136.

Through the control flow like this, a random number, a pattern of which is unable to analyze, can be generated with ease using a random network data as a parameter and used thereafter for generation of various security keys or the like.

Since those skilled in the art may make various substitutions, modifications and changes without departing from the scope and spirit of the invention, the present invention as described above is not limited to the above embodiments and the accompanying drawings.

What is claimed is:

1. A random number generation method performed by a communication apparatus, the method comprising the steps of:
extracting a network data transmitted through a short distance network;
determining a parameter to be updated among a plurality of parameters including a seed parameter used for random number generation using the extracted network data;
updating the determined parameter using the extracted network data; and
generating a random number according to a set random number generation algorithm using the seed parameter as an input variable.

2. The method according to claim 1, wherein the step of extracting a network data extracts, among valid network data, a network data positioned behind a previously extracted network data as much as a number set in an index parameter included in the plurality of parameters.

3. The method according to claim 1, wherein the step of determining a parameter to be updated determines the parameter to be updated using the extracted network data among the plurality of parameters through a modular arithmetic operation performed on a value of a counter operated by a predetermined clock, and
the step of updating the determined parameter sets a data created by processing the network data to the determined parameter.

4. The method according to claim 3, wherein the plurality of parameters include at least a seed parameter, a poly parameter and an index parameter, and
the step of determining a parameter to be updated determines a corresponding parameter determined among the seed parameter, the poly parameter and the index parameter through a modular arithmetic operation performed on the counter value as the parameter to be updated, and
the step of updating the determined parameter sets a data created by scrambling the network data to the determined parameter.

5. The method according to claim 4, wherein the step of updating the determined parameter sets the determined parameter as a scrambled data and initializing the index parameter when the determined parameter is the seed parameter or the poly parameter and the index parameter is set in advance through a previous update, and the determined parameter is not set when the index parameter is in an initialized state.

6. The method according to claim 1, wherein the plurality of parameters further include a poly parameter and an algorithm-index parameter, and
the step of generating a random number generates the random number according to a random number generation algorithm set in correspondence to the algorithm-index parameter updated with the network data by further using the poly parameter updated with the extracted network data as an input variable, and the network data is a data contained in a data link layer packet and having a predetermined size.

7. A random number generator comprising:
a data reception unit for receiving a network data through a short distance network;
a data extraction unit for extracting a network data to be used for parameter update from a plurality of network data received from the data reception unit;
a plurality of storage units for storing a plurality of parameters including a seed parameter, respectively;
a selection unit for selecting a storage unit corresponding to a parameter to be updated among the plurality of parameters of the plurality of storage units using the extracted network data; and
a random number generation unit for generating a random number according to a set random number generation algorithm using the seed parameter as an input variable.

8. The random number generator according to claim 7, wherein the data extraction unit extracts, among valid network data, a network data positioned behind a previously extracted network data as much as a data value stored in a storage unit corresponding to an index parameter included in the plurality of parameters, as a data to be used for parameter update.

9. The random number generator according to claim 7, wherein the selection unit including a counter operated by a predetermined clock and a modular arithmetic logic connected to an output value of the counter selects a storage unit corresponding to a parameter to be updated using the extracted network data among the plurality of parameters through a modular arithmetic operation performed on an output value of the counter, and
the storage unit corresponding to the selected parameter among the plurality of storage units stores a data created by processing the network data extracted by the data extraction unit.

10. The random number generator according to claim 9, wherein the plurality of parameters include at least a seed parameter, a poly parameter and an index parameter, and
the selection unit selects a storage unit corresponding to a parameter determined among the seed parameter, the poly parameter and the index parameter through a modular arithmetic operation performed on an output value of the counter, as a storage unit of the parameter to be updated, and the data extraction unit outputs a data created through scrambling of the extracted network data to the selection unit.

11. A communication apparatus comprising:
the random number generator according to claim 7; and
a central processing unit for transmitting and receiving data to and from the random number generator, wherein
the central processing unit requests the random number generator to generate a random number, and the random number generator transmits a random number generated in response to the request to the central processing unit.
